(19) United States
(12) Patent Application Publication
(10) Pub. No.: US 2017/0043416 A1
(43) Pub. Date: Feb. 16, 2017

(54) SELF-CLEANING MANDREL ASSEMBLY AND DRILL BIT

(71) Applicant: Ronald DOUGLAS, Mahwah, NJ (US)

(72) Inventor: Ronald DOUGLAS, Mahwah, NJ (US)

(21) Appl. No.: 15/045,610

(22) Filed: Feb. 17, 2016

Related U.S. Application Data
(60) Provisional application No. 62/117,886, filed on Feb. 18, 2015.

(51) Int. Cl. B23B 51/04

(52) U.S. Cl. CPC B23B 51/0453; B23B 51/0426; B23B 51/0473; B23B 2251/02; B23B 2251/428

(57) ABSTRACT

A mandrel assembly for attaching a hole saw and a pilot drill bit to an electric drill is disclosed. The mandrel assembly has a “self-clearing” feature that removes the “plug” without removing the mandrel from the drill chuck. The mandrel assembly includes a threaded shaft having a first end for attachment to a drill chuck, and a second end for receiving hole saw. The hole saw has a base disposed toward the chamfered end with the base having an opening therethrough and an ejection rod disposed substantially parallel to the threaded shaft between the chamfered end and the base. The ejection rod matingly engages and passes through the opening. When the drill bit is reversed, the ejection rod enters the interior space of the hole saw and clears the “plug” from the interior space of the hole saw.

### CROSS REFERENCED APPLICATION

This application is related, and claims priority, to U.S. Provisional Application No. 62/117,886 filed on Feb. 18, 2015, that is incorporated herein in its entirety by reference thereto.

### BACKGROUND OF THE DISCLOSURE

1. Field of the Disclosure

The present disclosure relates generally to a mandrel assembly adapted to attach a hole saw and a pilot drill bit to an electric drill. More particularly, the present disclosure relates to such a mandrel assembly that is designed and operated to have a “self-clearing” feature.

2. Background of the Disclosure

Many designs for a mandrel assembly for a hole saw and drill bit combination are known in the art. Representative publications showing such mandrel assemblies are U.S. Pat. No. 5,246,317 and EP Pub. 1462198. By way of general design, known mandrel assemblies have several parts in common. All assemblies have a pilot bit and a hole saw, in which the pilot bit serves the purpose of guiding the hole saw to the proper location in the workpiece. Also, known mandrel assemblies generally include a base mechanism and an adapter. In general terms, the base mechanism is designed for attachment to the chuck of, e.g., an electric drill, while the adapter is designed for mounting the hole saw/pilot bit combination to the base mechanism.

Regardless of design, a shortcoming of the prior art mandrel assemblies is that the “plug” of the workpiece cut out by the hole saw remains behind in the interior space of the hole saw and must be removed before the hole saw can be used to cut a new hole in the workpiece. Removal of the “plug” often entails removal of the mandrel from the electric drill and the use of an implement of some sort to remove the “plug” from the interior space of the hole saw. Generally speaking, the mandrel is removed from the chuck of the electric drill to simplify access to the “plug” remaining in the interior space of the hole saw, as well as to ensure the safety of the operator. Removing the mandrel from the electric drill is time-consuming, preventing the operator from proceeding to cut the next hole in the same or another workpiece. Coupled with the foregoing time delay is the additional delay caused by the need to remove the “plug” and to reinstall the mandrel into the chuck of electric drill.

Thus, a need exists for a mandrel that allows removal of the “plug” material from the interior space of the hole saw to be effected quickly and safely, without the need to remove the mandrel from the electric drill, and without the need to employ an additional implement, to remove the “plug”.

### SUMMARY OF THE DISCLOSURE

The present disclosure solves the above-mentioned need by providing a mandrel assembly with a “self-clearing” feature, namely to quickly and safely remove the “plug” (i.e., the cut portion of a workpiece) contained within the hole saw resulting from the action of the hole saw drilling through the workpiece.

The present disclosure also provides the self-clearing feature without removing the mandrel assembly from the drill chuck.

The present disclosure further provides the self-clearing feature without the need to employ an additional implement to remove the “plug”.

In one embodiment of the present disclosure, a mandrel assembly is provided that comprises: a threaded shaft comprised of a first end and a second end, the first end including a chamfered end for being held in a drill chuck, the second end comprising a threaded portion for matingly receiving a hole saw; the hole saw comprised of a base disposed toward the chamfered end, the base having at least one opening disposed therethrough and at least one movable rod that matingly engages the at least one opening, the movable rod disposed substantially parallel to the threaded shaft between the chamfered end and the base.

### BRIEF DESCRIPTION OF THE DRAWINGS

The mandrel assembly of the present disclosure will now be described in more detail with reference to the Figures.

FIG. 1 is a side view of a prior art mandrel assembly.

FIG. 2 is an exploded side view of a prior art mandrel assembly.

FIG. 3A is a side view of a mandrel assembly according to the present disclosure in cutting position.

FIG. 3B is a side view of a mandrel assembly according to the present disclosure in cutting position, with a partial transparent view of the hole saw with a “plug” therein.

FIG. 4A is a side view of a mandrel assembly of FIG. 3A in clearing position, with the “plug” (not shown) partially removed.

FIG. 4B is a side view of a mandrel assembly of FIG. 3A in cleared position, with the “plug” completely removed.

FIG. 5 is a front perspective view of the mandrel assembly of FIG. 4A (“plug” not shown).

FIG. 6 is a rear perspective view of the mandrel assembly of FIG. 4A.

FIGS. 7A and 7B show an overhead view and perspective view, respectively, of an alternate embodiment of a collar of the present disclosure.

In the detailed description of the preferred embodiment that follows, like numerals are used to designate like elements throughout the description of the Figures, although alternatives will be apparent to one of skill in the art based on the following detailed description.

### DETAILED DESCRIPTION OF THE PREFERRED EMBODIMENTS

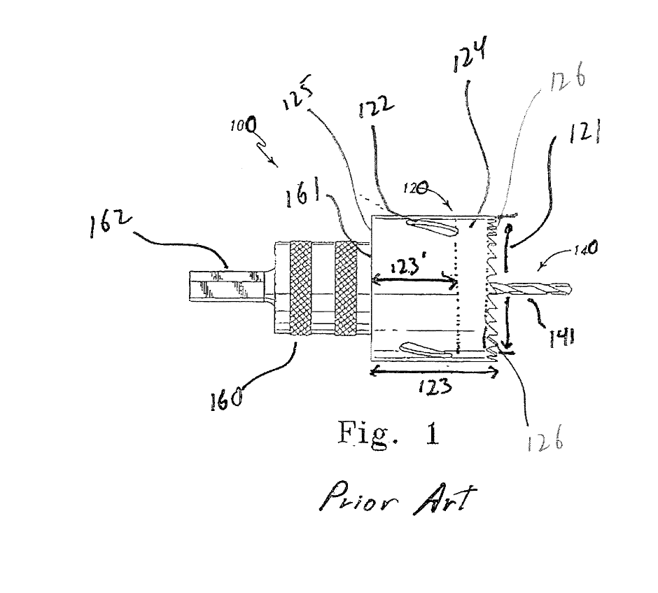

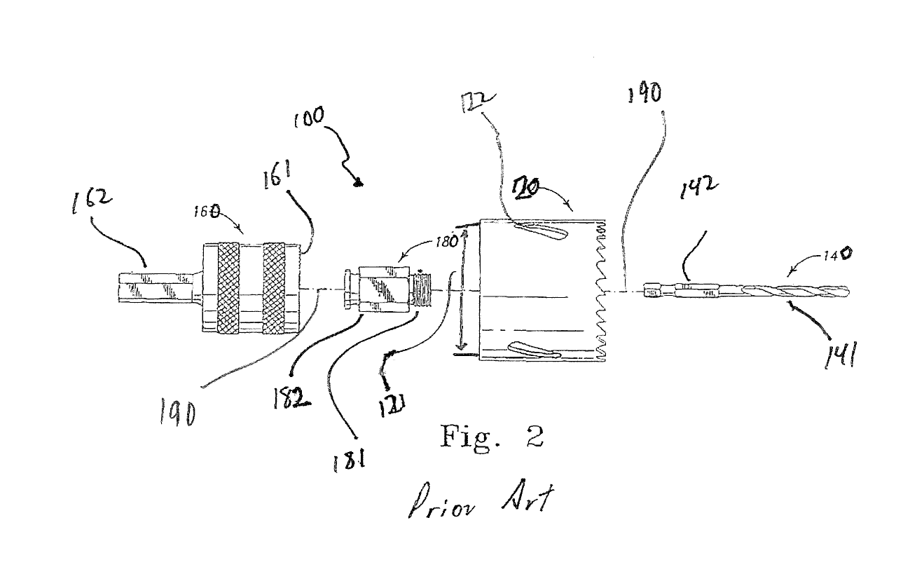

Referring to FIGS. 1 and 2, these Figures show a prior art mandrel assembly. The mandrel assembly 100 of FIG. 1 has a hole saw 120, a pilot bit 140 and a base mechanism 160. Hole saw 120 is generally cylindrical in shape with a thickness (shown at wall openings 122) that provides hole saw 120 with structural strength and support. The thickness of hole saw 120 shown at wall openings 122 provides hole saw 120 with an inside diameter (ID) 121. Hole saw 120 has a depth 123, reflecting the maximum thickness of a workpiece through which hole saw 120 may drill because teeth 126 must pass through workpiece completely in order to cut the desired hole in the workpiece. In operation, hole saw 120 generally also has wall openings 122 which are useful for allowing dust from teeth 126 passing through a workpiece (e.g., wood or concrete) or other waste produced by the action of hole saw 120 upon the workpiece to exit the interior space of hole saw 120 created by the workpiece (not shown) and the inside diameter 121 of hole saw 120. Wall openings 122 also allow for the venting of heat from the volume created between cut workpiece and a residual depth 123′ between bottom of the workpiece (shown by the dotted line in FIG. 1) and the base 125 of hole saw 120.

Base mechanism 160 has a proximal end 161 and a chamfered end 162. Proximal end 161 is disposed in relation to base 125 of hole saw 120 so as to receive a chamfered end 182 of adapter 180 (see, FIG. 2). Chamfered end 162 has geometry, as is known to those skilled in the art, suitable for insertion into an electric drill chuck (not shown). Adapter 180 has a threaded end 181 and chamfered end 182. Threaded end 181 threads into matching threaded opening (not shown) of hole saw 120. Threaded end 181 also receives chamfered end 142 of pilot bit 140 after threaded end 181 is threaded into threaded opening (not shown) of hole saw 120. Pilot bit 140 can be secured in chamfered end 182 using, e.g., a set screw (now shown). Cutting end 141 of pilot bit 140 serves to align hole saw 120 properly in relation to the workpiece. All of pilot bit 140, hole saw 120, adapter 180 and base mechanism 160 are concentrically aligned along longitudinal line 190 to ensure that power from the electric drill (not shown) is transmitted correctly through to hole saw 120 and to the workpiece along longitudinal line 190 (see, FIG. 2).

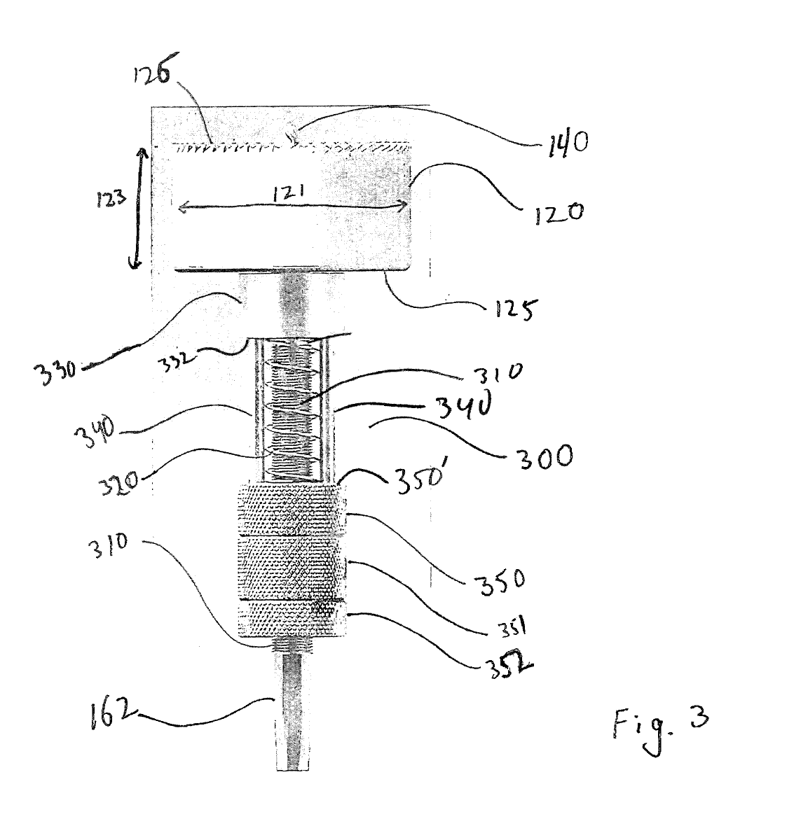

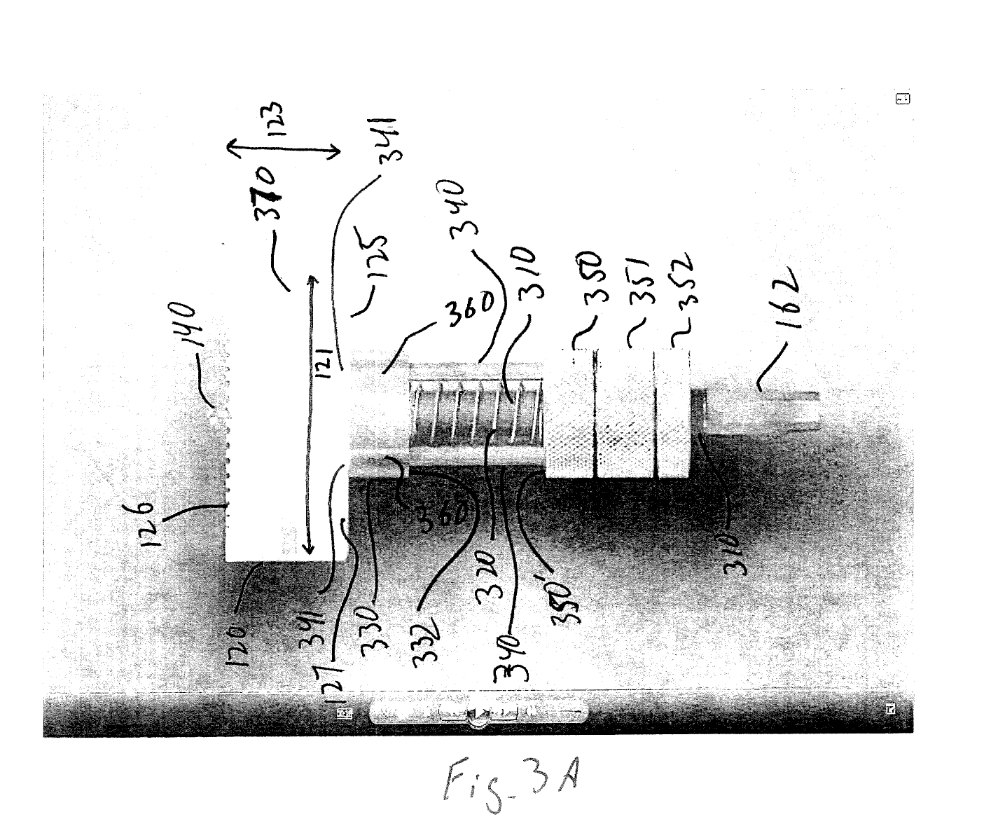

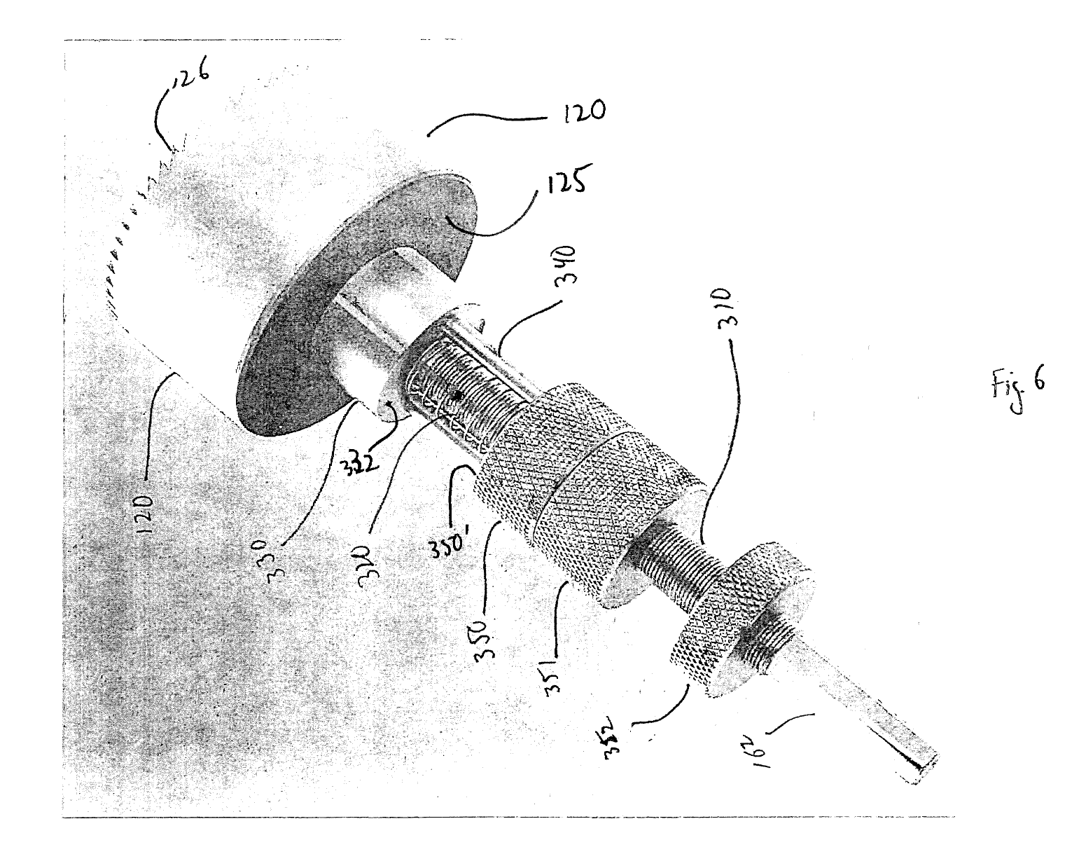

FIGS. 3A to 6 show different views of an embodiment of a mandrel assembly 300 of the present disclosure. In FIGS. 3A to 6, elements that are known according to the prior art of FIGS. 1 and 2 are designated with the same numbers as in FIGS. 1 and 2. Thus, elements 120, 121, 123, 125, 126, 140 and 162 are the same as shown in FIGS. 1 and 2.

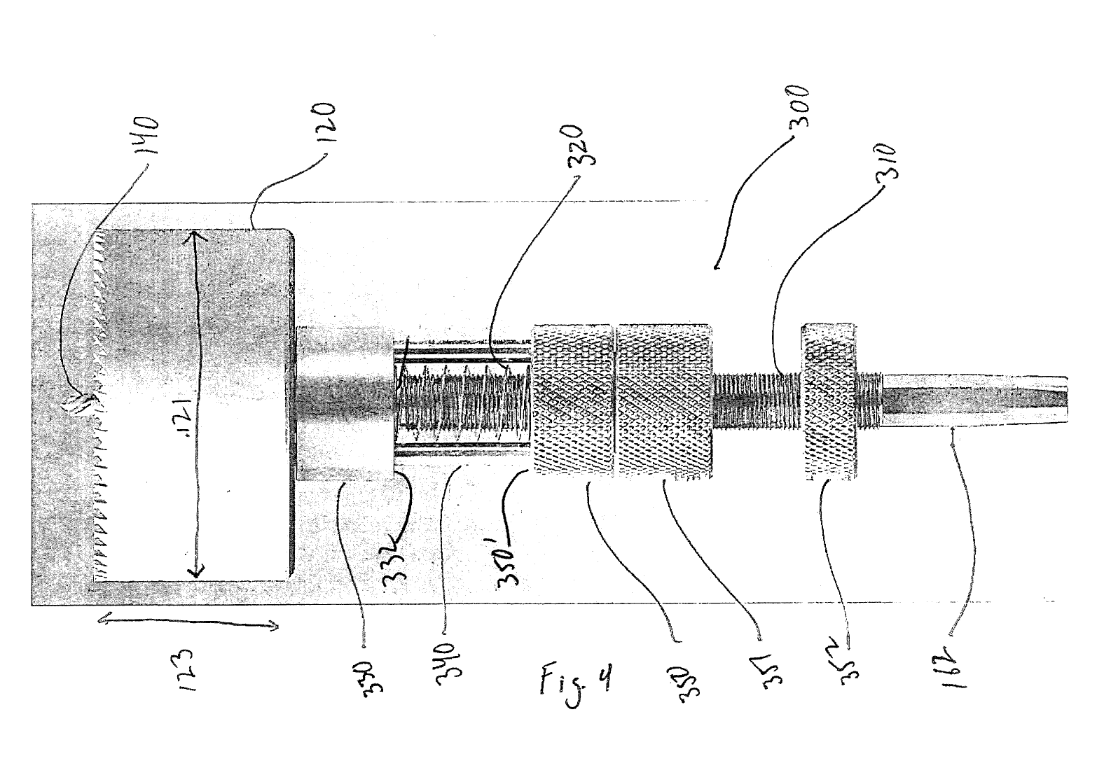

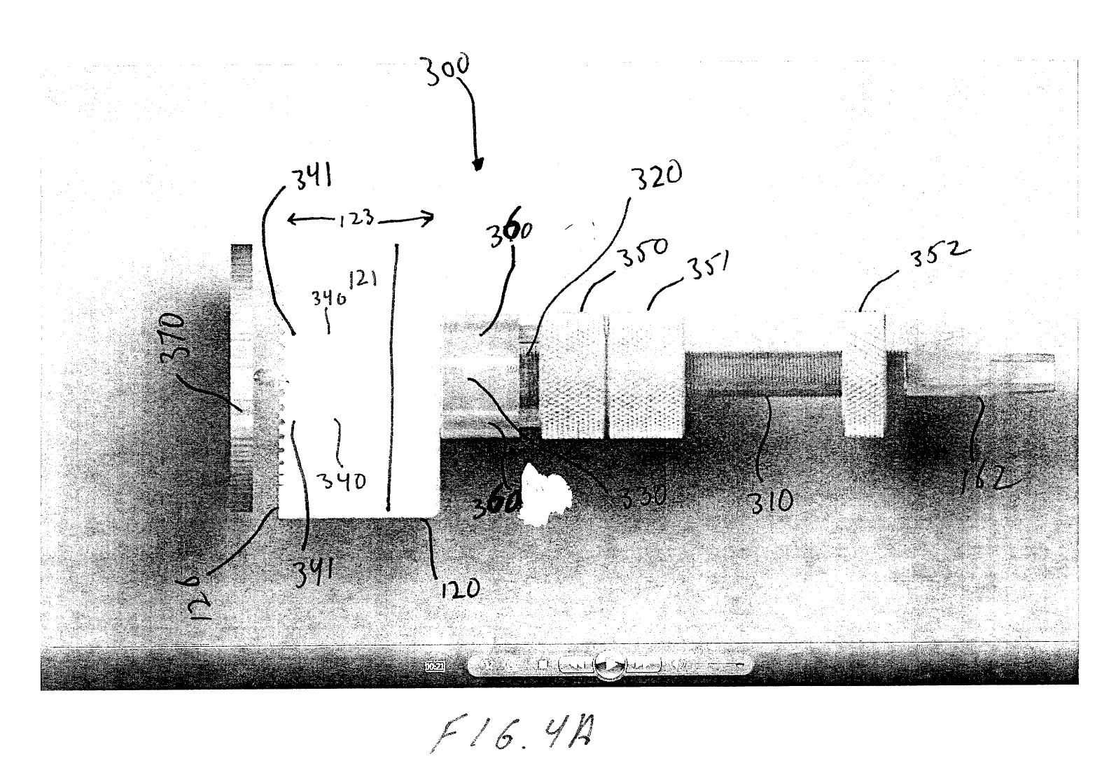

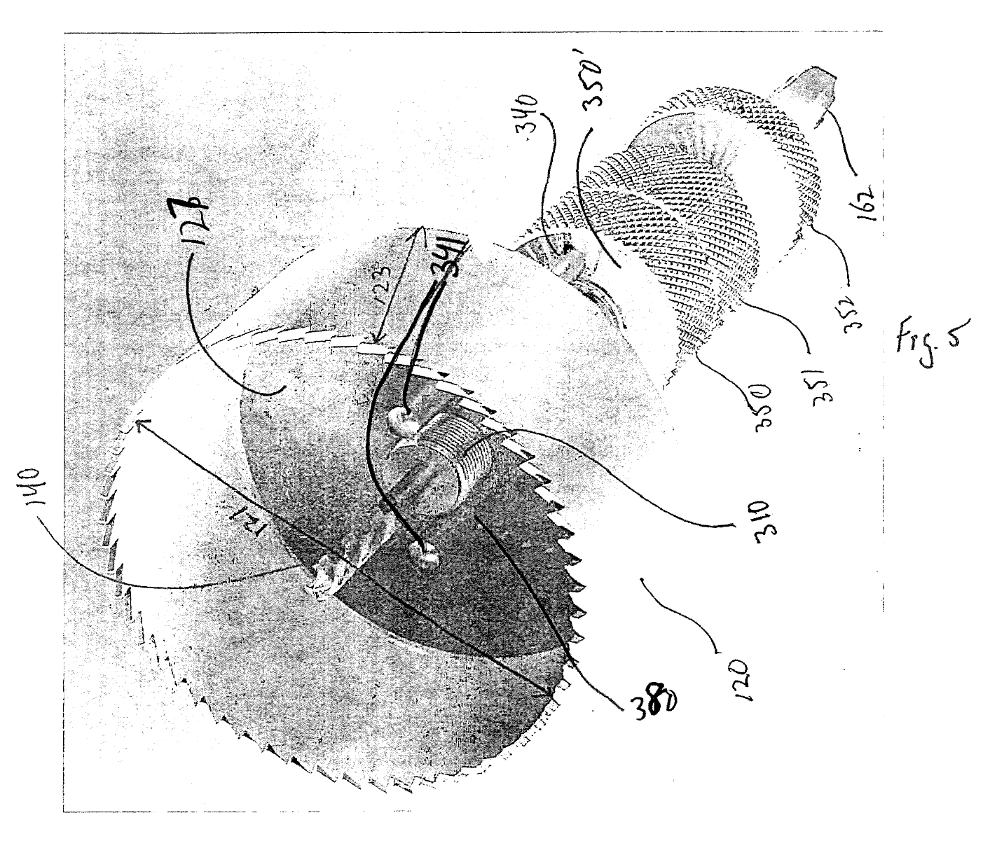

Referring to FIG. 3A, mandrel assembly 300 of the present disclosure comprises a threaded shaft 310, a tensioning spring 320, a pilot bit attachment/ejection rod guide collar 330, ejection rods 340 and a plurality of knurled knobs 350, 351 and 352. Ejection rods 340 are fixed to knurled knob 350 at top surface 350′ of knurled knob 350. Knurled knobs 351 and 352 function as a grip support and an ejection rod depth/stop support, respectively, as will be explained below. Pilot bit attachment/ejection rod guide collar 330 has channels therethrough (not shown) that are configured to accept ejection rods 340 and assist in guiding ejection rods 340 into and through openings 380 (see, FIG. 5) in base 125 of hole saw 120, as will also be explained below. Openings 380 align with the positioning and spacing of channels 360 (see, FIGS. 3B and 4B) through pilot bit attachment/ejection rod guide collar 330. Pilot bit attachment/ejection rod guide collar 330 may be fixedly attached to base 125 of hole saw 120 or may be a separate element. In FIG. 3A, mandrel assembly 300 is shown in the “cutting” position in which mandrel assembly 300 acts to cut a hole through a workpiece (not shown), in the same manner as the prior art mandrel assemblies shown in FIGS. 1 and 2, creating a plug 370 (see, FIGS. 3B and 4B). In operation, chamfered end 162 of threaded shaft 310 is inserted into a power drill chuck (not shown). As power is supplied, mandrel assembly 300 rotates in a clockwise direction against the workpiece and, guided by pilot bit 140, hole saw 120 cuts a hole in the workpiece the size of outside diameter 390 of hole saw 120. In “cutting” position, ejection rods 340 pass through pilot bit attachment/ejection rod guide collar 330 and are aligned with openings 380 in base 125 of hole saw 120. In “cutting” position, ends 341 (shown in FIGS. 3B and 5) of ejection rods 340 remain flush, or substantially flush, with the inside surface 127 (see, FIG. 3B) of base 125 of hole saw 120. In this manner, ends 341 of ejection rods 340 do not interfere with the operation of hole saw 120 as it cuts through the workpiece.

FIGS. 4 to 6 show several views of mandrel assembly 300 during “clearing” operation, i.e., when mandrel assembly 300 operates to clear plug 370 of the workpiece from the inside space of hole saw 120. “Clearing” operation will now be described with reference to FIGS. 4A to 6. When a hole has been cut through a workpiece using mandrel assembly 300 as shown in FIG. 3A, mandrel assembly 300 is removed from the workpiece. At that time, hole saw 120 retains plug 370 of the workpiece, which consists of the material removed during the cutting operation. To clear hole saw 120 of mandrel assembly 300 of the present disclosure, the following operation is performed. The operator grasps knurled knobs 350 and 351, and reverses electric drill (not shown) so that threaded shaft 310 of mandrel assembly 300 rotates in a counterclockwise direction. The counterclockwise rotation of threaded shaft 310 combined with the operator grasping knurled knobs 350 and 351 has the effect of causing pilot bit attachment/ejection rod guide collar 330 and hole saw 120 to move toward each other. As pilot bit attachment/ejection rod guide collar 330 and hole saw 120 and knurled knobs 350 and 351 are moved towards each other, ends 341 of ejection rods 340 enter and are extended into residual space 123′ through openings 380 and are urged against plug 370 of the workpiece remaining in the inside diameter 121 of hole saw 120. This can best be seen in FIGS. 4B and 5, in which ends 341 of ejection rods 340 have extended into residual depth 123′ of hole saw 120. Continued counterclockwise rotation of threaded shaft 310 by counterclockwise rotation of the drill chuck urges ends 341 of ejection rods 340 further into residual space 123′ until ends 341 of ejection rods 340 contact against plug 370. Ends 341 of ejection rods 340 continue to push against plug 370 until the plug 370 is ejected from the inside diameter 121 of hole saw 120.

Once plug 370 is ejected from inside diameter 121 of hole saw 120, mandrel assembly 300 is returned to “cutting” position as follows. While still grasping knurled knobs 350 and 351, operator reverses the rotation of drill chuck once again, so that drill chuck and mandrel assembly 300 are again rotated in a clockwise direction. As drill chuck rotates clockwise, threaded shaft 310 is urged forward through knurled knobs 350 and 351, and ejection rods 340 are pulled back from the inside space of hole saw 120, so that ends 341 of ejection rods 340 no longer reside in the inside space of hole saw 120. Rather, ends 341 of ejection rods 340 are returned to their cutting position flush, or substantially flush, with inside surface 127 of bottom 125 of hole saw 120. Knurled knob 352 serves to act as a “stop” so that knurled knobs 350 and 351, grasped by the operator cannot be retracted such that ejection rods 340 are pulled below or substantially below openings 380 in base 125 of hole saw 120. Knurled knob 352 acts as a “safety” device, ensuring that alignment of ejection rods 340 with pilot bit attachment/ejection rod guide collar 330 and openings 380 in base 125 is maintained.

Assembly of mandrel assembly 300 can be performed in various ways. Beginning with threaded shaft 310, pilot bit attachment/ejection rod guide collar 330 is placed on threaded shaft 310 (either by threading onto threaded shaft 310 or by having an inside diameter slightly greater than the diameter of threaded shaft 310 and sliding onto threaded shaft 310). Pilot bit attachment/ejection rod guide collar 330 can be held in place on threaded shaft 310 by use of a set screw. A sufficient amount of threaded shaft 310 is left exposed so that hole saw 120 can be threaded onto threaded shaft 310 and placed into communicative relation with pilot bit attachment/ejection rod guide collar 330. Preferably, the amount of threaded shaft 310 left exposed is such that when hole saw 120 is fully threaded onto threaded shaft 310, openings 380 in base 125 of hole saw 120 align with channels 360 of pilot bit attachment/ejection rod guide collar 330. In this embodiment, both hole saw 120 and pilot bit attachment/ejection rod guide collar 330 can be threaded to match the threads of shaft 310. Alternatively, pilot bit attachment/ejection rod guide collar 330 and hole saw 120 can be separate from each other and be separately threaded onto threaded shaft 310, starting with pilot bit attachment/ejection rod guide collar 330 that can be threaded onto threaded shaft 310, followed by threading hole saw 120 onto threaded shaft 310 until base 125 of hole saw 120 contacts, or nearly contacts, upper surface 331 of pilot bit attachment/ejection rod guide collar 330. In this embodiment, hole saw 120 can, additionally, be held in alignment with pilot bit attachment/ejection rod guide collar 330 through the use of an appropriately threaded nut (not shown) which is threaded onto threaded shaft 310 until it is matingly surfaced against inside surface 127 of hole saw 120. In a still further embodiment, pilot bit attachment/ejection rod guide collar 330 can have an inside diameter that is slightly greater than the outside diameter of threaded shaft 310, and pilot bit attachment/ejection rod guide collar 330 can be slipped into place on threaded shaft 310, held in place by, e.g., a set screw, and hole saw 120 can be threaded onto threaded shaft 310 until base 125 makes contact against upper surface 331 of pilot bit attachment/ejection rod guide collar 330. Also alternatively, hole saw 120 can have an inside diameter slightly greater than the outside diameter of the threaded shaft 310 and can be slipped onto threaded shaft 310 and held matingly surfaced against upper surface 331 of pilot bit attachment/ejection rod guide collar 330 using an appropriately threaded nut threaded onto threaded shaft 310 until the threaded nut contacts inside surface 127 of hole saw 120.

Continuing with assembly of mandrel assembly 300, proceeding from chamfered end 162 of threaded shaft 310, spring 320 is placed onto threaded shaft 310. Thereafter, knurled knob 350 having ejection rods 340 affixed thereto, is placed onto threaded shaft 310. Preferably, knurled knob has a substantially centrally located opening with an inner diameter that is slightly greater than the diameter of threaded shaft 310, simplifying placement of knurled knob 350 onto threaded shaft 310 and alignment of ejection rods 340 with channels 360. This action is followed by threading knurled knobs 351 and 352 onto threaded shaft 310. Threading knurled knobs 351 and 352 onto threaded shaft 310 continues until ends 341 of ejection rods 340 are flush or substantially flush with inside surface 127 of hole saw 120. When knurled knobs 351 and 352 are threaded onto threaded shaft 310 such that ends 341 of ejection rods 340 are flush or substantially flush with inside surface 127 of hole saw 120, knurled knob 352 is fixed in place by use of, e.g., a set screw.

In FIGS. 3A to 6, ejection rods 340 have been depicted as two ejection rods disposed in channels 360 through pilot bit attachment/ejection rod guide collar 330, spaced along a diameter line of pilot bit attachment/ejection rod guide collar 330, and spaced substantially equidistant from the center of pilot bit attachment/ejection rod guide collar 330. However, ejection rods 340 can be any number of ejection rods 340 spaced, preferably, on equally spaced radii emanating from the center of pilot bit attachment/ejection rod guide collar 330. Alternatively, ejection rods 340 can be spaced in a skewed arrangement through channels disposed in pilot bit attachment/ejection rod guide collar 330, or a single ejection rod 340 can be used in some embodiments. These latter two instances, i.e., skewed arrangement of ejection rods 340 and/or a single ejection rod 340, may not be preferred in all embodiments because, upon entering residual space 123′ as drill is reversed, these arrangements of ejection rod(s) 340 may have a tendency to tilt or skew plug 370 of the workpiece which then may become jammed in inside diameter 121 of hole saw 120. In an alternative embodiment, end(s) 341 of ejection rods 340 can have attached thereto a plate of square, rectangular, circular, oval, or any other desired shape, to provide increased surface area for the point of contact against plug 370. In this embodiment, a single rod 340 can more easily be used since it would be less likely that plug 370 would be caused to tilt and become jammed against inside diameter 121 of hole saw 120. In the embodiments where a plate is affixed to ends 341 of ejection rods 340, the plate can be fixed to ends 341 of ejection rods 340 after assembly of the mandrel assembly 300. Alternatively, ejection rods 340 can have such a plate permanently affixed thereto. In this embodiment, ejection rods 340 having a plate affixed thereto can be separate from and not a fixed to knurled knob 350. Rather, in this embodiment, ejection rods 340 can be placed into inner diameter 121 of hole saw 120, slipped through openings 380 and into alignment with channels 360 in pilot bit attachment/ejection rod guide collar 330, pass through channels 360 in pilot bit attachment/ejection rod guide collar 330 and then matingly engaged with suitably sized openings in knurled knob 350. In this embodiment, ejection rods 340 can be retained in openings of knurled knob 350 through the use of set screws or similar retention devices known to those of skill in the art. Of course, in embodiments where ejection rods 340 have a plate associated therewith, the plate will have an opening suitably sized to accommodate the diameter of pilot bit 140 and, preferably, threaded shaft 310.

Also, in the embodiments shown in FIGS. 3A-6, hole saw 120 has two openings 380 for accommodating two ejection rods 340. However, hole saw 120 can have an excess of openings 380 for accommodating ejection rods 340 or alternatively, hole saw may have curved slots. In an embodiment where hole saw has curved slots, the curved slots will have a width sufficient to accept the diameter, or other cross-sectional measurement, of ejection rods 340, and also be curved in a manner that is concentric with the curvature of the diameter of hole saw 120.

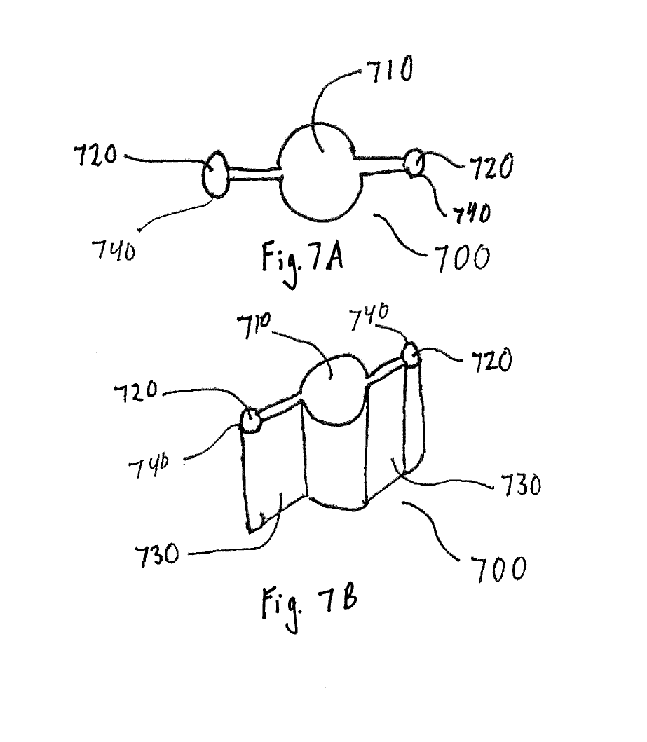

Although the preferred embodiments of the mandrel assembly 300 of the present disclosure utilize pilot bit attachment/ejection rod guide collar 330, pilot bit attachment/ejection rod guide collar 330 can have an alternative construction, or be absent altogether. One such alternative embodiment for pilot bit attachment/ejection rod guide collar 330 is depicted in FIGS. 7A and 7B.

Referring to FIGS. 7A and 7B, alternative collar 700 is has a center opening 710 and remote openings 720. Center opening 710 is connected to remote openings 720 via extensions 730. Center opening 710 could be threaded onto threaded shaft 310 or be slipped over threaded shaft 310, as described above with respect to pilot bit attachment/ejection rod guide collar 330. Remote openings 720 will be aligned with openings 380 in hole saw 120 and sized appropriately to matingly receive ejection rods 340. Likewise, collar 710 can, as with pilot bit attachment/ejection rod guide collar 330, have ejection rods affixed thereto or, alternatively, receive ejection rods 340 placed through openings 380 in hole saw 120 and slid into remote openings 720 to be thereafter affixed in position through the use of set screws or other known fasteners passing through wall 740 of remote openings 720.

As mentioned, pilot bit attachment/ejection rod guide collar 330 or 700 can be omitted, with ejection rods 340 proceeding directly from knurled knob 350 through openings 380 disposed in base 125 of hole saw 120. This configuration, however, is not preferred because of the tendency of ejection rods 342 to possibly become misaligned with openings 380 in hole saw 120, or to bend when in use. Also, in either of the embodiments of pilot bit attachment/ejection rod guide collar 330 or 700, ends 341 of ejection rods 340 can be disposed outside of interior space of hole saw 120 and away from opening 360 because the configuration of pilot bit attachment/ejection rod guide collar 330 and 700 provide alignment for end 341 of ejection rod 340 to correctly enter interior space.

Also, knurled knobs 351 and 352 are not required for the practice of the mandrel assembly 300 of the present disclosure, but are preferred. Knurled knob 351 is preferred so that the operator has a larger surface area to grip when drill is reversed. However, knurled knobs 350 and 351 can be combined into a single knurled knob. Likewise, knurled knob 352 can be omitted, although this is not preferred. If knurled knob 352 is omitted, this will necessitate the operator to visually observe the progress of ejection rods 340 out of space 123 to ensure that ends 341 of ejection rods 340 remaining flush or substantially flush with inside surface 126 of hole saw 120. Similarly, although in FIGS. 3A to 6 knurled knob 352 has been depicted as having substantially the same outer diameter as knurled knobs 350 and 351, this is not necessary.

In the above detailed description, the specific embodiments of this disclosure have been described in connection with its preferred embodiments. However, to the extent that the above description is specific to a particular embodiment or a particular use of this disclosure, this is intended to be illustrative only and merely provides a concise description of the exemplary embodiments. Accordingly, the disclosure is not limited to the specific embodiments described above, but rather, the disclosure includes all alternatives, modifications, and equivalents falling within the true scope of the appended claims. Various modifications and variations of this disclosure will be obvious to a worker skilled in the art and it is to be understood that such modifications and variations are to be included within the purview of this application and the spirit and scope of the claims.

All of the patents and publications referred to herein are incorporated herein by reference as if fully set forth herein.

What is claimed is:

1. A self-clearing mandrel assembly comprising:
a threaded shaft, the threaded shaft has a first end and a second end, the first end is a chamfered end adapted for being held in a drill chuck, the second end having a threaded portion;
a hole saw, wherein the threaded portion of the second end is adapted to receive the hole saw;
the hole saw having a substantially circular base and a side disposed away from and substantially perpendicular to the base to form an interior space, wherein the side has a cutting edge disposed on at least a portion of the side away from the base, wherein the base is disposed toward the chamfered end and has a first opening and a second opening disposed therethrough, wherein the first opening is disposed in the center of the base and is configured to receive the threaded shaft;
an ejection rod, wherein the ejection rod is adapted to be received in the second opening in the base between the first opening and the side; and
a grippable knob, the having a centrally located opening and is disposed along the threaded shaft between the first end and the substantially circular base;
wherein the ejection rod is disposed substantially parallel to the threaded shaft between the substantially circular base and the grippable knob, wherein the ejection rod has a first end adapted to matingly engage the second opening, and a second end adapted to fixedly engage the grippable knob, and wherein the first end is moveable from a first position substantially flush with the base to a second position disposed in the interior space.

2. The self-clearing mandrel assembly according to claim 1, wherein the first opening in the base is threaded so that the hole saw threads onto the second end of the threaded shaft, and further comprising a threaded nut configured to thread onto a portion of the second end of the threaded shaft extending into the interior space to affix the hole saw to the threaded shaft.

3. The self-clearing mandrel assembly according to claim 1, wherein the ejection rod comprises two ejection rods, wherein the second opening comprises two second openings.

4. The self-clearing mandrel assembly according to claim 3, wherein each of the two second openings is configured to receive one of the two ejection rods.

5. The self-clearing mandrel assembly according to claim 4, wherein each of the two ejection rods and each of the two second openings is spaced along a diameter line across the base.

6. The self-clearing mandrel assembly according to claim 5, wherein each of the two ejection rods and each of the two second openings is spaced equidistant from the first opening.

7. The self-clearing mandrel assembly according to claim 6, wherein the grippable knob has a knurled surface, wherein the grippable knob has two openings.

8. The self-clearing mandrel assembly according to claim 7, wherein each of the two openings is configured to accept one of the two ejection rods.

9. The self-clearing mandrel assembly according to claim 7, wherein the two ejection rods are retained in the two openings of knurled knob using set screws.

10. The self-clearing mandrel assembly according to claim 3, wherein the grippable knob comprises a first grippable knob and a second grippable knob, wherein the first grippable knob has two openings configured to accept one of the two ejection rods.

11. The self-clearing mandrel assembly according to claim 10, wherein the two ejection rods are retained in the two openings of the first grippable knob.

12. The self-clearing mandrel assembly according to claim 10, wherein the two ejection rods are retained in the two openings of the first grippable knob using set screws.

13. The self-clearing mandrel assembly according to claim 10, wherein the second grippable knob threads onto the threaded shaft.

14. The self-clearing mandrel assembly according to claim 13, wherein the second grippable knob is held in position using a set screw.

15. The self-clearing mandrel assembly according to claim 1, further comprising a collar.

16. The self-clearing mandrel assembly according to claim 15, wherein the collar is disposed along the threaded shaft between the grippable knob and the substantially circular base.

17. The self-clearing mandrel assembly according to claim 15, wherein the collar has two channels.

18. The self-clearing mandrel assembly according to claim 3, further comprising a collar, wherein the collar has two channels.

19. The self-clearing mandrel assembly according to claim 18, wherein each of the two channels is configured to accept one of the two ejection rods.

20. A self-clearing mandrel assembly comprising:
a threaded shaft, the threaded shaft has a first end and a second end, the first end is a chamfered end adapted for being held in a drill chuck, the second end having a threaded portion;
a hole saw, wherein the threaded portion of the second end is adapted to receive the hole saw;
the hole saw having a substantially circular base and a side disposed away from and substantially perpendicular to the base to form an interior space, wherein the side has a cutting edge disposed on at least a portion of the side away from the base, wherein the base is disposed toward the chamfered end and has a first opening and a second opening disposed therethrough, wherein the first opening is disposed in the center of the base and is configured to receive the threaded shaft;
two ejection rods, each of the two ejection rods adapted to be received in the second opening in the base between the first opening and the side; and
a first grippable knob and a second grippable knob, each of the first and second grippable knobs having a centrally located opening and is disposed along the threaded shaft between the first end and the substantially circular base;
wherein each ejection rod is disposed substantially parallel to the threaded shaft between the substantially circular base and the grippable knob, wherein each ejection rod has a first end adapted to matingly engage the second opening, and a second end adapted to fixedly engage the grippable knob, and wherein the first end is moveable from a first position substantially flush with the base to a second position disposed in the interior space.
